(19) United States
(12) Patent Application Publication
(10) Pub. No.: US 2021/0331314 A1
(43) Pub. Date: Oct. 28, 2021

(54) ARTIFICIAL INTELLIGENCE CLEANER

(71) Applicant: LG ELECTRONICS INC., Seoul (KR)

(72) Inventor: Seungah CHAE, Seoul (KR)

(73) Assignee: LG ELECTRONICS INC., Seoul (KR)

(21) Appl. No.: 16/499,813

(22) PCT Filed: Mar. 8, 2019
(86) PCT No.: PCT/KR2019/002718

§ 371 Date: Sep. 30, 2019

(51) Int. Cl. B25J 9/16; B25J 9/00; B25J 11/00; B25J 13/00; A47L 9/28; G06F 3/16; G10L 15/22; G06K 9/00; G06K 9/62

(52) U.S. Cl. CPC B25J 9/1666; G10L 2015/223; B25J 9/161; B25J 11/0085; B25J 13/003; A47L 9/2857; A47L 9/2826; A47L 9/2852; G06F 3/167; G10L 15/22; G06K 9/00664; G06K 9/6217; A47L 2201/04; A47L 2201/06; B25J 9/0003

(57) ABSTRACT

An artificial intelligence cleaner includes a memory, a microphone configured to receive a speech command, an image sensor configured to acquire image data, a driving unit configured to drive the artificial intelligence cleaner, and a processor configured to determine whether a cleaning instruction image is recognized using the image data when the speech command input to the microphone is a command for designating an area to be preferentially cleaned, acquire a position of a user using the image data when the cleaning instruction image is recognized, and controls the driving unit to move the artificial intelligence cleaner to the acquired position of the user.

### TECHNICAL FIELD

The present invention relates to an artificial intelligence cleaner and, more particularly, to an artificial intelligence cleaner capable of automatically cleaning a designated cleaning area using a user's speech and image.

### BACKGROUND ART

A robot cleaner may refer to a device for sucking in foreign materials such as dust from a floor to automatically perform cleaning while autonomously traveling in an area to be cleaned without user operation.

Such a robot cleaner performs cleaning operation while traveling along a predetermined cleaning route according to a program installed therein.

A user does not know the cleaning route of the robot cleaner. Accordingly, when the user wants to preferentially clean a specific area, the user waits until the robot cleaner arrives at the specific area or changes the operation mode of the robot cleaner to a manual control mode using a remote controller capable of controlling the robot cleaner and then moves the robot cleaner using the direction key of the remote controller.

In this case, it is inconvenient for the user to wait until the area which needs to be preferentially cleaned is cleaned.

In addition, a conventional robot cleaner includes an image sensor provided therein, thereby recognizing a dirty area and intensively cleaning the dirty area. However, it is difficult to recognize the dirty area as much as the user.

### DISCLOSURE

### Technical Problem

An object of the present invention devised to solve the problem lies in an artificial intelligence cleaner capable of easily cleaning an area to be preferentially cleaned based on a user's speech and image.

Another object of the present invention devised to solve the problem lies in an artificial intelligence cleaner capable of acquiring an area to be preferentially cleaned and intensively performing cleaning with respect to the acquired area to be preferentially cleaned.

Another object of the present invention devised to solve the problem lies in an artificial intelligence cleaner capable of grasping the intention of a speech command and image data of a user and determining an area to be preferentially cleaned.

### Technical Solution

An artificial intelligence cleaner according to an embodiment of the present invention can recognize an area to be preferentially cleaned using a user's speech command and a user image and move to the recognized area to be preferentially cleaned to perform cleaning.

An artificial intelligence cleaner according to an embodiment of the present invention can change a cleaning mode of an area to be preferentially cleaned from a normal cleaning mode to a meticulous cleaning mode.

An artificial intelligence cleaner according to an embodiment of the present invention can determine a cleaning instruction area using analysis of the intention of the speech command of the user and a machine learning based recognition model of image data.

### Advantageous Effects

According to the embodiment of the present invention, since a desired area is rapidly cleaned by only a simple speech and gesture without operation of a remote controller for controlling a robot cleaner, it is possible to improve user satisfaction.

According to the embodiment of the present invention, since visual information of a user is reflected, it is possible to clean a cleaning area which may be overlooked by a robot cleaner.

### DESCRIPTION OF DRAWINGS

FIG. 1 is a diagram showing the configuration of an artificial intelligence cleaner according to an embodiment of the present invention.

FIG. 2 is a plan view of an artificial intelligence cleaner according to an embodiment of the present invention, and FIG. 3 is a bottom view of an artificial intelligence cleaner according to an embodiment of the present invention.

FIG. 4 is a flowchart illustrating a method of operating an artificial intelligence cleaner according to an embodiment of the present invention.

FIG. 5 is a view illustrating an example of determining whether a cleaning instruction image of an acquired image is recognized using a cleaning instruction image recognition model according to an embodiment of the present invention.

FIGS. 6 and 7 are views illustrating a scenario in which an artificial intelligence cleaner recognizes a speech command and a cleaning instruction image of a user and performs cleaning with respect to an area designated by the user.

FIGS. 8 and 9 are views illustrating a process of selecting a cleaning designation area according to an embodiment of the present invention.

FIG. 10 is a view illustrating an example in which an artificial intelligence cleaner cleans a cleaning designation area in a meticulous cleaning mode according to an embodiment of the present invention.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” or “unit” may be used to refer to elements or components. Use of such a suffix herein is merely intended to facilitate description of the specification, and the suffix itself is not intended to have any special meaning or function.

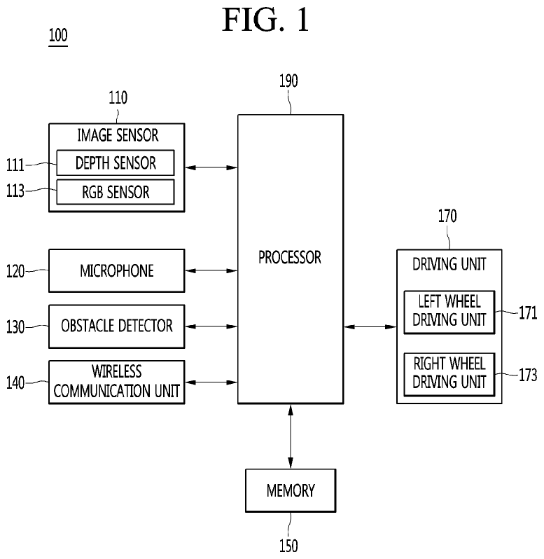

FIG. 1 is a diagram showing the configuration of an artificial intelligence cleaner according to an embodiment of the present invention.

Referring to FIG. 1, the artificial intelligence cleaner 100 according to the embodiment of the present invention may include an image sensor 110, a microphone 120, an obstacle detector 130, a wireless communication unit 140, a memory 150, a driving unit 170 and a processor 190.

The image sensor 110 may acquire image data of the periphery of the artificial intelligence cleaner 100.

The image sensor 110 may include at least one of a depth sensor 111 or an RGB sensor 113.

The depth sensor 111 may detect light returned after light emitted from a light emitting unit (not shown) is reflected from an object. The depth sensor 111 may measure a distance from the object based on a difference in time when the returned light is detected and the amount of returned light.

The depth sensor 111 may acquire two-dimensional image information or a three-dimensional image information of the periphery of the cleaner 100 based on the measured distance from the object.

The RGB sensor 113 may acquire color image information of an object around the cleaner 100. The color image information may be a captured image of an object. The RGB sensor 113 may be referred to as an RGB camera.

The obstacle detector 130 may include an ultrasonic sensor, an infrared sensor, a laser sensor, etc. For example, the obstacle detector 130 may irradiate a laser beam to a cleaning area and extract a pattern of the reflected laser beam.

The obstacle detector 130 may detect an obstacle based on the extracted position and pattern of the laser beam.

When the depth sensor 110 is used to detect an obstacle, the obstacle detector 130 may be omitted.

The wireless communication unit 140 may include at least one of a wireless Internet module and a short-range communication module.

The mobile communication module transmits and receives wireless signals to and from at least one of a base station, an external terminal or a server over a mobile communication network established according to technical standards or communication methods for mobile communication (e.g., GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), etc.).

The wireless Internet module refers to a module for wireless Internet access and may be installed inside or outside the terminal 100. The wireless Internet module is configured to transmit and receive wireless signals over a communication network according to the wireless Internet technologies.

Examples of the wireless Internet technology include, for example, WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), etc.

The short-range communication module is configured to facilitate short-range communication. For example, short-range communication may be supported using at least one of Bluetooth™, Radio Frequency IDentification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), or the like.

The memory 150 may store a cleaning instruction image recognition model for recognizing a cleaning instruction image showing a cleaning area indicated by a user using the image data acquired by the image sensor 110.

The driving unit 170 may move the artificial intelligence cleaner 100 by a specific distance in a specific direction.

The driving unit 170 may include a left wheel driving unit 171 for driving the left wheel of the artificial intelligence cleaner 100 and a right wheel driving unit 173 for driving a right wheel.

The left wheel driving unit 171 may include a motor for driving the left wheel and the right wheel driving unit 173 may include a motor for driving the right wheel.

Although the driving unit 170 is shown as including the left wheel driving unit 171 and the right wheel driving unit 173 in FIG. 1, the present invention is not limited thereto. When the number of wheels is one, only one driving unit may be provided.

The processor 190 may control overall operation of the artificial intelligence cleaner 100.

The processor 190 may analyze the intention of a speech command input through the microphone 120.

The processor 190 may determine whether the speech command is a command for designating an area to be preferentially cleaned according to the result of analyzing the intention.

Upon determining that the speech command is a command for designating the area to be preferentially cleaned, the processor 190 may acquire an image using the image sensor 110.

The processor 190 may determine whether a cleaning instruction image is recognized from the acquired image.

The processor 190 may acquire image data from the image sensor 110 and determine whether the cleaning instruction image is recognized using the acquired image data and a cleaning instruction image model.

When the cleaning instruction image is not recognized from the acquired image, the processor 190 controls the driving unit 170 such that the direction of the artificial intelligence cleaner 100 is changed. Thereafter, the processor 190 may perform the image acquisition step again.

When the cleaning instruction image is recognized from the acquired image, the processor 190 may acquire the position of the user based on the image data.

The processor 190 may control the driving unit 170 to move the acquired position of the user.

The processor 190 may perform cleaning with respect to an area in which the user is located, after moving the artificial intelligence cleaner 100 to the position of the user.

Detailed operation of the processor 190 will be described below.

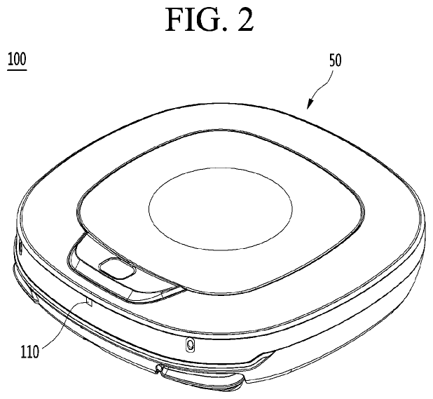

FIG. 2 is a perspective view of an artificial intelligence cleaner according to an embodiment of the present invention, and FIG. 3 is a bottom view of an artificial intelligence cleaner according to an embodiment of the present invention.

Referring to FIG. 2, the artificial intelligence cleaner 100 may include a cleaner body 50 and a depth sensor 110 provided on the upper surface of the cleaner body 50.

The depth sensor 110 may irradiate light forward and receive reflected light.

The depth sensor 110 may acquire depth information using a time difference of received light.

The cleaner body 50 may include the components other than the depth sensor 110 among the components described with reference to FIG. 1.

Referring to FIG. 3, the artificial intelligence cleaner 100 may further include the cleaner body 50, a left wheel 61a, a right wheel 61b and a suction unit 70 in addition to the configuration of FIG. 1.

The left wheel 61a and the right wheel 61b may move the cleaner body 50.

A left wheel driving unit 171 may drive the left wheel 61a and a right wheel driving unit 173 may drive the right wheel 61b.

As the left wheel 61a and the right wheel 61b rotate by the driving unit 170, foreign materials such as dust and trash may be sucked through the suction unit 70.

The suction unit 70 may be provided in the cleaner body 50 to suck dust on a floor.

The suction unit 70 may further include a filter (not shown) for collecting foreign materials from the sucked air stream and a foreign material container (not shown) for storing the foreign materials collected by the filter.

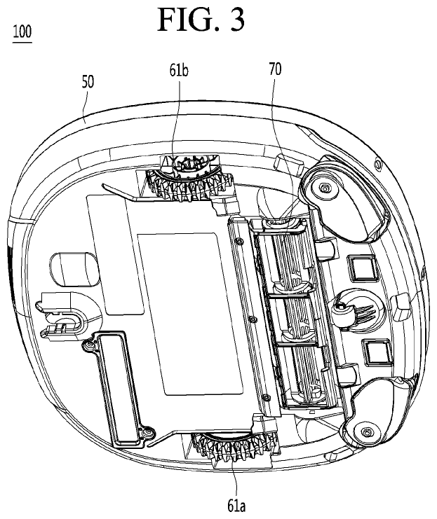

FIG. 4 is a flowchart illustrating a method of operating an artificial intelligence cleaner according to an embodiment of the present invention.

The microphone 120 of the artificial intelligence cleaner 100 receives a speech command uttered by a user (S401).

The artificial intelligence cleaner 100 may be in motion or located at a fixed position when the speech command uttered by the user is received.

The processor 190 analyzes the intention of the received speech command (S403).

The received speech command may include an activation command and an operation command.

The activation command may be a command for activating the artificial intelligence cleaner 100.

The activation command or text corresponding to the activation command may be prestored in the memory 150.

Upon determining that the stored activation command matches the activation command received through the microphone 120, the processor 190 may determine that the processor is selected for operation control of the artificial intelligence cleaner 100.

In another example, the processor 190 may receive the activation command before the speech command is received and determine that the process is selected for operation control of the artificial intelligence cleaner 100 according to the received activation command.

When the activation command is recognized, the processor 190 may analyze the intention of the user using the operation command.

The processor 190 may convert the operation command into text and analyze the intention of the user using the converted text.

For example, the processor 190 may transmit the converted text to a natural language processing (NLP) server through the wireless communication unit 140 and receive a result of analyzing the intention from the NLP server.

The NLP server may analyze the intention of the text based on the received text.

The NLP server may sequentially perform a morpheme analysis step, a syntax analysis step, a speech-act analysis step, a dialog processing step with respect to text data, thereby generating intention analysis information.

The morpheme analysis step refers to a step of classifying the text data corresponding to the speech uttered by the user into morphemes as a smallest unit having a meaning and determining the part of speech of each of the classified morphemes.

The syntax analysis step refers to a step of classifying the text data into a noun phrase, a verb phrase, an adjective phrase, etc. using the result of the morpheme analysis step and determines a relation between the classified phrases.

Through the syntax analysis step, the subject, object and modifier of the speech uttered by the user may be determined.

The speech-act analysis step refers to a step of analyzing the intention of the speech uttered by the user using the result of the syntax analysis step. Specifically, the speech-act step refers to a step of determining the intention of a sentence such as whether the user asks a question, makes a request, or expresses simple emotion.

The dialog processing step refers to a step of determining whether to answer the user's utterance, respond to the user's utterance or ask a question to inquire additional information.

The NLP server may generate intention analysis information including at least one of the intention of the user's utterance, the answer to the intention, a response, or additional information inquiry, after the dialog processing step.

In another example, the processor 190 may include a natural language processing engine. In this case, the processor 190 may analyze the intention of the converted text using the natural language processing engine.

That is, the natural language processing engine may perform the function of the NLP server.

The natural language processing engine may be provided in the processor 190 or may be provided separately from the processor 190.

The processor 190 determines whether the speech command is a command for designating an area to be preferentially cleaned according to the result of analyzing the intention (S405).

The processor 190 may determine whether an operation command included in the speech command is a command indicating an area to be preferentially cleaned using the result of analyzing the intention.

When an intention indicating a specific cleaning area is included in the result of analyzing the intention, the processor 190 may determine that the operation command is a command for designating the area to be preferentially cleaned.

For example, when the operation command includes a word such as <here> or <there>, the processor 190 may determine that the user has an intention of indicating the specific cleaning area.

Upon determining that the speech command is a command for designating the area to be preferentially cleaned, the processor 190 acquires an image using the image sensor 110 (S407).

Upon determining that the speech command is a command for designating the area to be preferentially cleaned, the processor 190 may activate the image sensor 110 and acquire a peripheral image.

The image sensor 110 reads subject information and converts the read subject information into an electrical image signal.

The artificial intelligence cleaner 100 may include a camera and the camera may include various types of image sensors 110.

The image sensor 110 may include at least one of a CCD (Charged Coupled Device) image sensor or a CMOS (Complementary Metal Oxide Semiconductor) sensor.

The processor 190 determines whether a cleaning instruction image is recognized from the acquired image (S409).

In one embodiment, the processor 190 may compare the acquired image with a cleaning instruction image prestored in the memory 150 and determine whether the cleaning instruction image is recognized from the acquired image.

For example, the processor 190 may compare the acquired image with the cleaning instruction image prestored in the memory 150 and determine a matching degree. When the matching degree is equal to or greater than a predetermined degree, the processor 190 may determine that the cleaning instruction image is recognized from the acquired image.

In contrast, when the matching degree is less than a predetermined degree, the processor 190 may determine that the cleaning instruction image is not recognized from the acquired image.

In another example, the processor 190 may determine whether the cleaning instruction image is recognized from the acquired image using a machine learning algorithm.

Specifically, the processor 190 may determine whether the cleaning instruction image is recognized using a learned cleaning instruction image recognition model.

The cleaning instruction image recognition model may indicate an artificial neural network based model learned by a machine learning algorithm or a deep learning algorithm.

The cleaning instruction image recognition model may be a personalized model individually learned for each user who uses the artificial intelligence cleaner 100.

The cleaning instruction image recognition model may be stored in the memory 150.

For example, the cleaning instruction image recognition model stored in the memory 150 may be learned through the processor 190 of the artificial intelligence cleaner 100 and then stored.

In another example, the cleaning instruction image recognition model stored in the memory 150 may be received from an external server through the wireless communication unit 140 and then stored.

The cleaning instruction image recognition model may be a model learned to infer whether the cleaning instruction image indicating feature points is recognized using, as input data, learning data having the same format as user image data indicating a user image.

The cleaning instruction image recognition model may be learned through supervised learning.

Specifically, the learning data used to learn the cleaning instruction image recognition model may be labeled with whether the cleaning instruction image is recognized (cleaning instruction image recognition success or cleaning instruction image recognition failure) and the cleaning instruction image recognition model may be learned using the labeled learning data.

The cleaning instruction image recognition model may be learned with the goal of accurately inferring whether the labeled cleaning instruction image is recognized from given image data.

The loss function (cost function) of the cleaning instruction image recognition model may be expressed by the square mean of a difference between labels indicating whether the cleaning instruction image corresponding to each learning data is recognized and whether the cleaning instruction image inferred from each learning data is recognized.

In the cleaning instruction image recognition model, model parameters included in an artificial neural network may be determined to minimize the loss function, through learning.

When an input feature vector is extracted from image data and is input, the cleaning instruction image recognition model may be learned to output a result of determining whether the cleaning instruction image is recognized as a target feature vector and to minimize the loss function corresponding to a difference between the output target feature vector and whether the labeled cleaning instruction image is recognized.

For example, the target feature point of the cleaning instruction image recognition model may be composed of an output layer of a single node indicating whether the cleaning instruction image is recognized. That is, the target feature point may have a value of 1 in the case of the cleaning instruction image recognition success and have a value of 0 in the case of cleaning instruction image failure. In this case, the output layer of the cleaning instruction image recognition model may be an activation function and use a sigmoid, a hyperbolic tangent, etc.

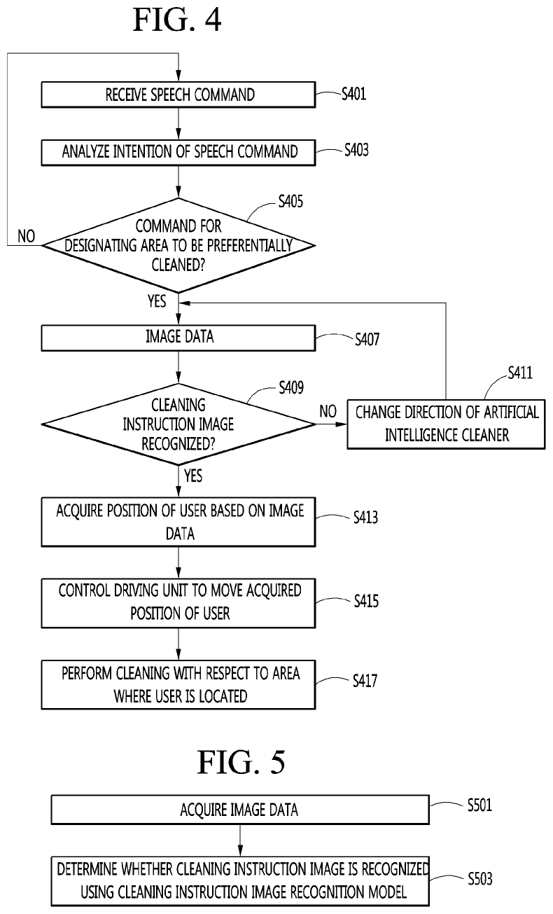

FIG. 5 is a view illustrating an example of determining whether a cleaning instruction image of an acquired image is recognized using a cleaning instruction image recognition model according to an embodiment of the present invention.

The processor 190 acquires image data from the image sensor 110 (S501), and determines whether the cleaning instruction image is recognized using the acquired image data and the cleaning instruction image recognition model (S503).

Step S501 may correspond to step S407 of FIG. 4 and step S503 may correspond to step S409.

The processor 190 may determine whether cleaning instruction image recognition succeeds or fails using the image data acquired from the image sensor 110 and the cleaning instruction image recognition model stored in the memory 150.

When cleaning instruction image recognition succeeds or fails, the processor 190 may output a notification through an output unit (not shown). The output unit may include one or more of a speaker or a display.

FIG. 4 will be described again.

When the cleaning instruction image is not recognized from the acquired image, the processor 190 controls the driving unit 170 to change the direction of the artificial intelligence cleaner 100 (S411). Thereafter, the processor 190 performs the image acquisition step again (S407).

In one embodiment, when the cleaning instruction image is not recognized from the acquired image, the processor 190 may control the driving unit 170 to rotate the direction of the artificial intelligence cleaner 100 by a certain angle.

Here, the certain angle may be 30 degrees and this is merely an example.

The processor 190 may rotate the artificial intelligence cleaner 100 by the certain angle and acquire an image again through the image sensor 110.

Thereafter, the processor 190 may determine whether the cleaning instruction image is recognized from the reacquired image.

The processor 190 may repeatedly perform step S411 until the cleaning instruction image is recognized.

The processor 190 may store the rotation angle in the memory 150 when cleaning instruction image recognition succeeds.

When the cleaning instruction image is recognized from the acquired image, the processor 190 acquires the position of the user based on the image data (S413).

Upon determining that the cleaning instruction image is successfully recognized from the acquired image, the processor 190 may acquire a distance between the artificial intelligence cleaner 100 and the user corresponding to the cleaning instruction image based on the image data.

The depth sensor 111 of the image sensor 110 may detect light returned after light emitted from a light emitting unit (not shown) is reflected from an object. The depth sensor 111 may measure a distance from the object based on a difference in time when the returned light is detected and the amount of returned light.

When the cleaning instruction image is recognized from the image data, the processor 110 may measure the distance between the user corresponding to the cleaning instruction image and the artificial intelligence cleaner 100.

The processor 190 controls the driving unit 170 to move the acquired position of the user (S415).

That is, the processor 190 may control the driving unit 170 to move the artificial intelligence cleaner 100 by the measured distance.

The processor 190 moves the artificial intelligence cleaner 100 to the position of the user and then performs cleaning with respect to an area where the user is located (S417).

The position of the user may indicate a point where the cleaning instruction image is recognized. The area where the user is located may be a circular area having a radius of a certain distance from the position where the cleaning instruction image is recognized. However, this is merely an example and the area has the other shape such as a square.

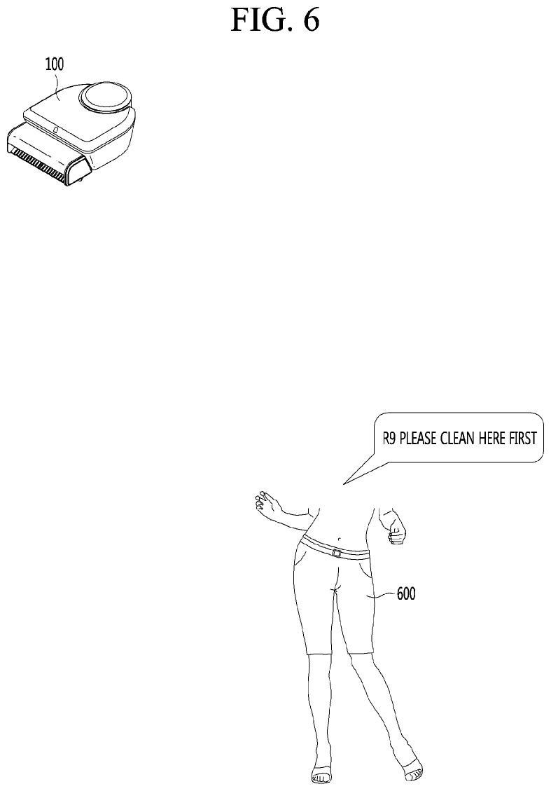

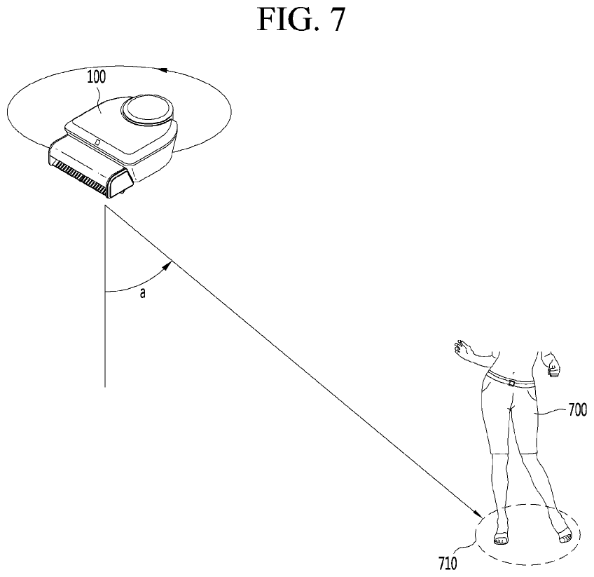

FIGS. 6 and 7 are views illustrating a scenario in which an artificial intelligence cleaner recognizes a speech command and a cleaning instruction image of a user and performs cleaning with respect to an area designated by the user.

Referring to FIG. 6, the artificial intelligence cleaner 100 may receive a speech command <R9, please clean here first> uttered by the user through the microphone 120.

Here, <R9> may correspond to the activation command and <Please clean here first> may correspond to the operation command.

The artificial intelligence cleaner 100 may determine whether the intention of the operation command is to designate a specific cleaning area as an area to be preferentially cleaned, through analysis of the intention of the operation command.

Determination of intention analysis may be performed by the natural language processing server or the artificial intelligence cleaner 100 as described above.

The artificial intelligence cleaner 100 may acquire an image 600 through the image sensor 110 when the intention of designating the area to be preferentially cleaned is confirmed through analysis of the intention of the operation command.

The artificial intelligence cleaner 100 may determine whether the cleaning instruction image is successfully recognized from the acquired image 600.

Specifically, the artificial intelligence cleaner 100 may determine whether the cleaning instruction image is recognized using the image data corresponding to the acquired image 600 and the cleaning instruction image recognition model.

Referring to FIG. 7, the artificial intelligence cleaner 100 may acquire the image while rotating by a certain angle a until the cleaning instruction image is successfully recognized.

The cleaning instruction image may include a pair of legs of the user.

The artificial intelligence cleaner 100 may determine whether the cleaning instruction image (the image of the pair of legs) is recognized using the cleaning instruction image recognition model learned to recognize the pair of legs of the user 700 and the acquired image 600.

Upon determining that the cleaning instruction image is successfully recognized from the acquired image, the artificial intelligence cleaner 100 may move to the cleaning designation area 710 where the user 700 is located.

For example, the cleaning designation area 710 may include the soles of the feet of the user.

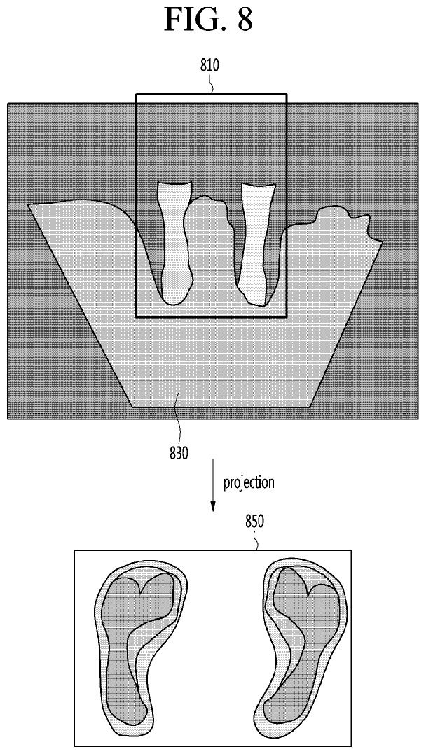

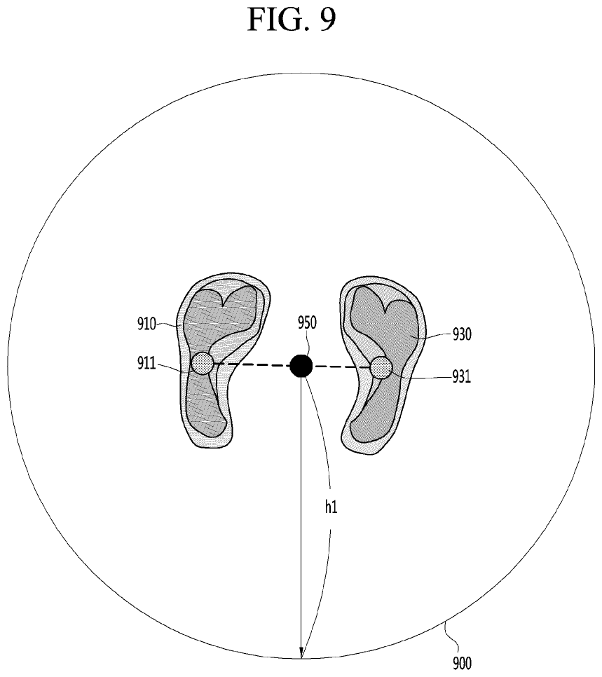

FIGS. 8 and 9 are views illustrating a process of selecting a cleaning designation area according to an embodiment of the present invention.

In particular, FIG. 8 is a view illustrating a process of projecting the pair of legs determined as the cleaning instruction image onto a floor plane to acquire a projected sole area at the artificial intelligence cleaner 100.

The processor 190 may project the pair of legs 810 determined as the cleaning instruction image on the floor plane 830. Therefore, a pair-of-soles area 850 may be acquired. The pair-of-soles area 850 may be used to acquire the cleaning designation area 710.

The processor 190 may acquire the position of the user using a relative position between the sole areas configuring the pair-of-soles area 850.

The relative position between the sole areas may be a center point of a segment connecting the center of the left sole area with the center of the right sole area.

Referring to FIG. 9, the left sole area 910 and the right sole area 930 included in the pair-of-soles area 850 are shown.

The processor 190 may acquire a center point 950 of a segment connecting the center 911 of the left sole area 910 with the center 931 of the right sole area 930.

The processor 190 may recognize the center point 950 of the segment as the position of the user.

The processor 190 may determine a circular area 900 centered on the center point 950 and having a radius of a length corresponding to a certain distance hl as the cleaning designation area 710.

Although the circular area 900 is shown as being determined as the cleaning designation area 710 in FIG. 9, this is merely an example. That is, the cleaning designation area may have a square shape centering on the center point 950.

The processor 190 may perform cleaning with respect to the cleaning designation area 710 after moving to the position 950 of the user.

The processor 190 may change a cleaning mode when cleaning is performed with respect to the cleaning designation area 710. Assume that the cleaning mode includes a normal cleaning mode and a meticulous cleaning mode (or a concentrated cleaning mode).

The meticulous cleaning mode has a longer time required for the artificial intelligence cleaner 100 to clean a cleaning area and stronger dust suction force than the normal cleaning mode.

The meticulous cleaning mode may be a mode in which cleaning is performed while the cleaner moves in the cleaning designation area in a zigzag manner.

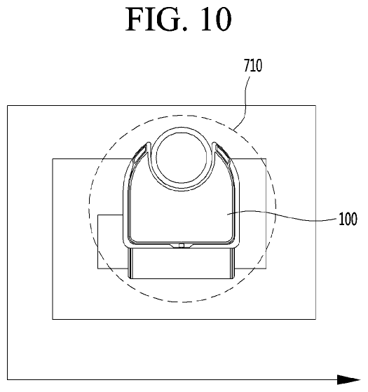

FIG. 10 is a view illustrating an example in which an artificial intelligence cleaner cleans a cleaning designation area in a meticulous cleaning mode according to an embodiment of the present invention.

Referring to FIG. 10, a cleaning designation area 710 obtained by the speech command of the user and the cleaning instruction image is shown.

The artificial intelligence cleaner 100 may travel in the cleaning designation area 710 in a zigzag manner and clean the cleaning designation area 710.

According to the embodiment of the present invention, the user can control the artificial intelligence cleaner 100 to clean a desired cleaning area, by only utterance of a simple speech command and a simple gesture.

Therefore, a remote controller for operating the artificial intelligence cleaner 100 is not necessary, thereby significantly improving user convenience.

Meanwhile, the processor 190 may pre-store a map of the inside of a house in the memory 150 using a simultaneous localization and mapping (hereinafter referred to as SLAM) algorithm.

The processor 190 may tag and pre-store the coordinate information of the cleaning designation area in the obtained map in the memory 150 based on the speech command of the user and the cleaning instruction image.

When the cleaning designation area is a circular area, the center of the circle and the radius of the circle may be used to extract coordinate information and may be stored in the memory 150.

When the cleaning designation area is a square area, the center of the square and the length of one side of the square may be used to extract coordinate information and may be stored in the memory 150.

When cleaning is performed in the meticulous cleaning mode with respect to the cleaning designation area certain times or more, the processor 190 may determine the cleaning designation areas as a cleaning area of interest. The certain number of times may be 3, but it is merely an example.

The processor 190 may change the normal cleaning mode to the meticulous cleaning mode, when entering the cleaning area of interest while performing cleaning along a cleaning route in the normal cleaning mode.

That is, the processor 190 may change the cleaning mode of the cleaning area of interest without separate calling of the user, thereby more concentratively performing cleaning.

Therefore, cleaning may be automatically performed with respect to an area where cleaning is not performed well or an area where the user wants to clean up, thereby improving user satisfaction.

The present invention mentioned in the foregoing description can also be embodied as computer readable codes on a computer-readable recording medium. The computer-readable recording medium may include all types of recording devices in which data readable by a computer system is stored. Examples of computer-readable mediums include HDD (Hard Disk Drive), SSD (Solid State Disk), SDD (Silicon Disk Drive), ROM, RAM, CD-ROM, a magnetic tape, a floppy disk, an optical data storage device, etc.

The above detailed description is to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. An artificial intelligence cleaner comprising:
a memory;
a microphone configured to receive a speech command;
an image sensor configured to acquire image data;
a driving unit configured to drive the artificial intelligence cleaner; and
a processor configured to determine whether a cleaning instruction image is recognized using the image data when the speech command input to the microphone is a command for designating an area to be preferentially cleaned, acquire a position of a user using the image data when the cleaning instruction image is recognized, and controls the driving unit to move the artificial intelligence cleaner to the acquired position of the user.

2. The artificial intelligence cleaner according to claim 1, wherein the processor acquires a cleaning designation area corresponding to the position of the user and controls the driving unit to clean the acquired cleaning designation area.

3. The artificial intelligence cleaner according to claim 2,
wherein a cleaning mode of the artificial intelligence cleaner includes a normal cleaning mode and a meticulous cleaning mode,
wherein the processor changes the normal cleaning mode to the meticulous cleaning mode to clean the cleaning designation area.

4. The artificial intelligence cleaner according to claim 1, wherein the processor acquires an intention of the speech command and acquires the image data through the image sensor when the acquired intention is to designate the area to be preferentially cleaned.

5. The artificial intelligence cleaner according to claim 1,
wherein the processor determines whether recognition of the cleaning instruction image succeeds using the image data and a cleaning instruction image recognition model stored in the memory,
wherein the cleaning instruction image recognition model is an artificial neural network based model learned to infer whether the cleaning instruction image is recognized using, as input data, learning data having the same format as user image data.

6. The artificial intelligence cleaner according to claim 5, wherein the processor rotates the artificial intelligence cleaner by a certain angle when recognition of the cleaning instruction image fails based on the image data, and acquires image data again through the image sensor.

7. The artificial intelligence cleaner according to claim 2, wherein the processor:
acquires a pair-of-soles area from the recognized cleaning instruction image, and
acquires a center of the acquired pair-of-soles area as the position of the user.

8. The artificial intelligence cleaner according to claim 7, wherein the processor determines a circular area having a radius of a certain length from the acquired position of the user as the cleaning designation area.

9. A method of operating an artificial intelligence cleaner, the method comprising:
receiving a speech command;
acquiring image data when the received speech command is a command for designating an area to be preferentially cleaned;
determining whether a cleaning instruction image is recognized using the acquired image data;
acquiring a position of a user using the image data when the cleaning instruction image is recognized; and
controlling a driving unit to move the artificial intelligence cleaner to the acquired position of the user.

10. The method according to claim 9, further comprising:
acquiring a cleaning designation area corresponding to the position of the user; and
controlling the driving unit to clean the acquired cleaning designation area.

11. The method according to claim 9, further comprising:
acquiring an intention of the speech command; and
acquiring the image data through an image sensor when the acquired intention is to designate the area to be preferentially cleaned.

12. The method according to claim 9, further comprising:
determining whether recognition of the cleaning instruction image succeeds using the image data and a cleaning instruction image recognition model stored in a memory,
wherein the cleaning instruction image recognition model is an artificial neural network based model learned to infer whether the cleaning instruction image is recognized using, as input data, learning data having the same format as user image data.

13. The method according to claim 12, further comprising:
rotating the artificial intelligence cleaner by a certain angle, when recognition of the cleaning instruction image fails based on the image data; and
acquiring image data again through an image sensor.

14. The method according to claim 10, further comprising acquiring a pair-of-soles area from the recognized cleaning instruction image, and
wherein the acquiring of the position of the user includes acquiring a center of the acquired pair-of-soles area as the position of the user.

15. The method according to claim 14, further comprising determining a circular area having a radius of a certain length from the acquired position of the user as the cleaning designation area.
